(19) United States
(12) Patent Application Publication
(10) Pub. No.: US 2019/0066394 A1
(43) Pub. Date: Feb. 28, 2019

(54) POSTAGE STAMP ISSUING SYSTEM USING A STAMP CARD AND ITS EMBODIMENT METHOD

(71) Applicant: Young Jin LEE, Gyeonggi-do (KR)

(72) Inventor: Young Jin LEE, Gyeonggi-do (KR)

(21) Appl. No.: 16/079,799

(22) PCT Filed: Feb. 15, 2017
(86) PCT No.: PCT/KR2017/001633

§ 371 Date: Aug. 24, 2018

(30) Foreign Application Priority Data
Feb. 29, 2016 (KR) 10-2016-0023899
Jun. 27, 2016 (KR) 10-2016-0080166

(51) Int. Cl. G07B 17/00; B42D 15/00; G06Q 20/36

(52) U.S. Cl. CPC G07B 17/00508; G07B 2017/00588; G06Q 20/36; B42D 15/0073

(57) ABSTRACT

In an exemplary embodiment of the present invention, the stamp issuing method using a stamp card comprises these steps: offer a sales procedure by stamp card type and issue stamp cards through the procedure; receive purchase request signals from a user terminal, offer a procedure to select mail options and decide a payment method according to the information and service type chosen by the user through the procedure; offer a payment procedure depending on whether pre-payment or post-payment or a procedure to print a postal registration certificate; and offer a procedure to issue a stamp or print out an FDC after the postage is payed through the procedure.

### BACKGROUND

The exemplary embodiments of the present invention relate to a postage stamp issuing system using a stamp card and its embodiment method.

The current typical form of paper stamps has some 170 years of history since its first publication in 1840 in the UK. Previously, most of mail was correspondence to send greetings. But, thanks to advanced means of communications, personal devices like a smartphone are replacing such a role.

Nevertheless, with a growing number of important documents and parcels posted worldwide, mail is way more necessary than ever. These days, rates for registered mail and parcels are high and vary according to their weight. So, people are bothered to put together several stamps (to meet the exact price) and affix them to an envelope with a glue. To address this inconvenience, many countries introduced stickers to simply print postage rates.

This makes using a stamp gradually uncomfortable. Now a stamp is more about promotion and collection than about payment and thus countries issue stamps with a focus on profits from collectors.

Korean Patent Publication No. 10-2011-0010557 relates to a real-time mobile stamp system and its implementation method. This system enables users to access mail services anytime anywhere with their cell phones.

### SUMMARY OF THE INVENTION

An object of the present invention is to provide a postage stamp issuing system using a stamp card and its embodiment method in order to issue a stamp card that can be repeatedly used as a stamp until the amount of money marked on the front is depleted.

Another object of the invention is to provide a postage stamp issuing system using a stamp card and its embodiment method in order to facilitate the profits from stamp card auction to be utilized for raising funds.

Yet another object of the invention is to provide a postage stamp issuing system using a stamp card and its embodiment method in order to enable users to pay postage and print out a stamp or first day cover (FDC) through their printer.

Further object of the invention is to provide a postage stamp issuing system using a stamp card and its embodiment method in order to 1) enable users to register information on a mailed item, pay its postage, print out a postal registration certificate, and affix it to the item and 2) enable a postal worker to collect and send it. By doing so, a card holder doesn't need to visit the post office in person to send mail.

Problems the present invention aims to deal with are not limited to the aforementioned one(s) and other(s) may become clear by the relevant person through the following description.

Among the exemplary embodiments disclosed herein, the stamp issuing method using a stamp card comprises these steps: 1) offer a sales procedure by stamp card type and issue stamp cards through the procedure; 2) receive purchase request signals from a user terminal, offer a procedure to select mail options and decide a payment method according to the information and service type chosen by the user through the procedure; 3) offer a payment procedure depending on whether pre-payment or post-payment or a procedure to print a postal registration certificate; and 4) offer a procedure to issue a stamp or print out an FDC after the postage is payed through the procedure.

Among the embodiments, the stamp issuing method using a stamp card comprises a stamp card management server, user terminals and output equipment. First, the stamp card management server offers a sales procedure by stamp card type and issues stamp cards through the procedure; receives purchase request signals from a user terminal, offers a procedure to select mail options and decides a payment method according to the information and service type chosen by the user through the procedure; offers a payment procedure depending on whether pre-payment or post-payment or a procedure to print a postal registration certificate; and offers a procedure to issue a stamp or print out an FDC after the postage is payed through the procedure. Second, the user terminals log into the said stamp card server; buy stamp cards according to the said card sales procedure, select an option through the said procedure to select mail options; pay postage calculated based on the option information; and generate signals for issuing a stamp or printing an FDC. Finally, the output equipment prints out stamps according to signals from the user terminal.

Specific matters on other embodiments appear in detailed description and attached drawings.

The advantages and/or features, and their achievement method will be obvious upon detailed description of the exemplary embodiments as well as accompanied drawings which follow. However, the present invention is not limited to those embodiments set forth herein and can be embodied in many different forms. The embodiments are provided only to render the present disclosure complete and the scope of the invention comprehensible to those having ordinary skills in the art. This invention is only to be defined by the claims. A same reference mark used refers to a same element throughout the specification.

According to the present invention, its advantage is to enable post stamp cards functioning as a stamp to be issued and used repeatedly until the amount of money marked on their front is depleted.

According to the present invention, its advantage is to be able to utilize the profits from stamp card auction for raising funds.

According to the present invention, its advantage is to enable users to pay postage and print out a stamp or a first day cover (FDC) through their printer.

According to the present invention, its advantage is to enable users to register information on a mailed item, pay its postage, print out a postal registration certificate, and affix it to the item and to enable a postal worker to collect and send it. By doing so, a card holder doesn't need to visit a post office in person to send mail.

### BRIEF DESCRIPTION OF THE DRAWINGS

FIG. 1 is a network composition diagram illustrating a postage stamp issuing system using a stamp card according to a first exemplary embodiment of the present invention.

FIGS. 2 and 3 are diagrams illustrating the implementation process of FIG. 1.

FIGS. 4 and 5 are diagrams illustrating a stamp card according to a first exemplary embodiment of the present invention.

FIG. 6 is a network composition diagram illustrating a postage stamp issuing system using a stamp card according to a second exemplary embodiment of the present invention.

FIG. 7 is a diagram illustrating the implementation process of FIG. 6.

FIG. 8 is a network composition diagram illustrating a postage stamp issuing system using a stamp card according to a third exemplary embodiment of the present invention.

FIGS. 9 and 10 are diagrams illustrating the implementation process of FIG. 8.

FIG. 11 is a network composition diagram illustrating a postage stamp issuing system using a stamp card according to a forth exemplary embodiment of the present invention.

### DETAILED DESCRIPTION OF THE INVENTION

In the following, the embodiments of the present invention are described in detail based on the accompanied drawings.

The term “stamp card” used in this specification refers to a card used to pay postage and can take on the form of credit card or debit card. There are two types of stamp cards: regular cards for the public and commemorative cards issued through auction.

The monetary value marked on the front of a stamp card mentioned above is to pay for the postage rate. Although it is usually denominated in USD as an international base currency, it may be subject to change according to situations.

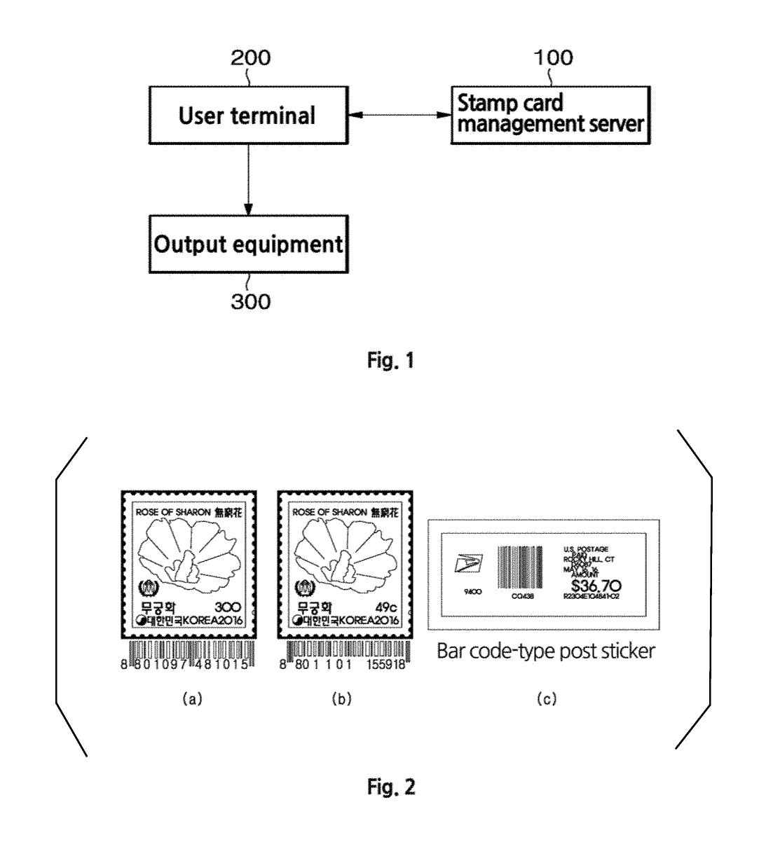

FIG. 1 is a network composition diagram illustrating a postage stamp issuing system using a stamp card according to a first exemplary embodiment of the present invention.

As seen in FIG. 1, the postage stamp card management system comprises a stamp card management server (100), user terminals (200) and output equipment (300).

The stamp card management server (100) offers a sales procedure for stamp cards by type and issues them after the cards are sold through the procedure.

In an exemplary embodiment, the stamp card management server (100) plays a role of selling and delivering a certain type of regular stamp cards through a sales procedure. Here, regular cards mean those anyone can buy and use to pay postage.

In another embodiment concerning commemorative stamp cards, the stamp card management server (100) offers a card auction procedure and issues stamp cards for the winners among those who engaged in the procedure.

To that end, the stamp card management server (100) produces stamp cards based on the purpose of issuance, effective period, available value denominated in national currency, stamp number and data to access the stamp card management server and then provides a card auction procedure for user terminals (200).

In an exemplary embodiment, the stamp card management server (100) can prompt bidding competition among users by determining a stamp number as a commemorative number. For instance, if the stamp number is “601224”, a user whose birthday is Dec. 24, 1960 may prefer it.

In a different exemplary embodiment, the stamp card management server (100) can set a time period longer than a specific duration from the issue date (e.g., 50 or 100 years) as an effective period to raise sovereign credit rating and promote card sales.

Subsequently, the stamp card management server (100) receives signals from user terminals (200) to bid for a specific stamp card through the auction procedure; compares the users' bidding price and the denomination on the card up for auction by way of those signals; and permits them to join the stamp card auction only when the former is larger than the latter.

Moreover, the stamp card management server (100) designates a particular user as an auction winner among the bidders; issues a stamp card according to a method requested through the card by the winner (e.g., perforation or imperforation) and deals with its delivery to the said winner.

In other words, since this invention takes an order for a stamp card before the issuance, it can factor in the users' preference by giving them options of perforation and imperforation and enhance the rarity of the card.

When the stamp card management server (100) issues stamp cards using other cards, it engraves information on the auction winner (e.g., English name), resulting in more competition among the users to buy the first card and stronger desires for them to buy the cards.

After an auction process is completed as mentioned above, the stamp card management server (100) incinerates unsold cards and updates a stamp card list. In short, the server (100) burns the cards, notifies a latest card list to users, and subtracts the number of unsold cards from the list.

In the analogue era, it was impossible to modify the quantity of one-time postage stamps issued. Yet, in today's digital era, official increase or decrease of stamp cards as a digital stamp becomes available. This may well stimulate transparent purchase competition as a result of variable card prices as we see in the stock market.

The stamp card management server (100) provides information on each used or unused card by card. If a price for the unused goes up, its scarcity value also rises and the users are reluctant to pay postage with the card. This will present the country of issue with greater profits as much as the denomination marked on the card.

The stamp card management server (100) generates a mobile stamp card for each card issued to the user and provides it to the relevant user terminal (200). Therefore, the stamp card management server (100) helps users to pay postage conveniently with a mobile card without its physical counterpart.

After the stamp card management server (100) receives purchase request signals from user terminals (200), it provides a procedure to select mail options such as stamps, envelopes, cachets, plastic covers and item types. Then the server (100) determines postage rates based on information on selected options.

When a figure is chosen for an envelope through the option selection procedure, the stamp card management server (100) charges a price according to the type of the image to be inserted.

If the inserted image for an envelope was uploaded by the stamp card holder, the stamp card management server (100) does not charge its price.

By contrast, the inserted image was uploaded by another user, the stamp card management server (100) imposes a postage rate as much as the amount determined by the image uploader or according to the type of the uploader. For example, in case that the person is a famous painter, the postage rate is levied as much as the amount determined by the painter's grade.

The stamp card management server (100) provides a postage payment procedure depending on whether the postage rate is determined by the information on mail options selected through the designated procedure. After the postage was payed through the payment procedure, the server (100) transmits signals on completed payment to user terminals (200).

In an exemplary embodiment, when regular mail is chosen through the mail option selection procedure, the stamp card management server (100) provides a postage payment procedure using the information on mail options. In case of this embodiment, a card holder prints out a stamp or an FDC through the personal output device after paying postage.

In another exemplary embodiment, although registered mail is chosen through the mail option selection procedure, the stamp card management server (100) provides a procedure to print a postal registration certificate to the home pickup service user. In case of this embodiment, a card holder prints out a postal registration certificate, affixes it to the mailed item and conveys it to the postal worker. The collected item is weighed at a post office as registered mail and then the user implements post-payment using information chosen through the mail weight and option selection procedure for registered mail.

A different exemplary embodiment is the case that though an item of mail is registered mail, the user has a printer dedicated to mail that can weigh the item. Under this condition, the stamp card management server (100) receives its weight data from the equipment, decides its postage using information chosen through the mail weight and option selection procedure, and offers a postage payment procedure. In case of this embodiment, a stamp card holder can print out a stamp or an FDC via the dedicated output equipment after paying postage for the registered mail.

Postage rates vary according to the accurate weight of mailed items in the aforementioned embodiment. So, the rates for items with the same weight may be charged differently depending on whether the item belongs to a person who operates a personal post office or a person who visits the post office to pay for it. Against this backdrop, the stamp card management server (100) compares both rates to check out the accuracy of the weight of the mailed items, accordingly levies penalties on the user and decides whether to allow him or her to keep running the post office based on those penalties.

When the stamp card management server (100) executes payment with a stamp card as mentioned above, it compares the remainder out of the initial card value and the postage rate to verify that the payment is available. If the former is more than the latter, the server (100) handles the stamp purchase process and updates the remaining amount of money.

This means that when the remainder out of the initial value marked on the card is greater than the postage rate, the stamp card management server (100) proceeds with the stamp purchase process and updates the remaining amount of money.

The stamp card management server (100) provides a procedure to print an FDC through an output device (300) connected with a user terminal (200) according to the desired reception method transmitted by the terminal (200) or proceeds with delivery of a stamp and an FDC with a commemorative stamp according to delivery destination information sent by the terminal (200).

User terminals (200) refer to the units held by users who contact the stamp card management server (100), buy stamp cards through its sales procedure and pay postage with their cards. These user terminals (200) can take on the form of a PDA or smartphone.

In an exemplary embodiment, user terminals (200) contact the stamp card management server (100) to receive data on the stamp card sales procedure and buy regular stamp cards through the procedure.

In yet another exemplary embodiment, user terminals (200) contact the stamp card management server (100) to receive data on the commemorative card auction procedure and join the stamp card auction through the procedure. User terminals (200) set a bidding price in participating in the auction through the stamp card auction procedure. Here, the bidding price shall be larger than the denomination on the card.

In the above exemplary embodiment, user terminals (200) receive signals notifying that a user has won the auction and provide the winner's information (e.g., English name) and a card issuing method (e.g., perforation or imperforation) to the stamp card management server (100).

User terminals (200) can also check information from the stamp card management server (100). Users scan the code (e.g. barcode, QR code, etc.) on the back of the stamp card that represents contact information with the stamp card management server (100). Then their terminals (200) contact the server (100) using the information corresponding to the code.

In an exemplary embodiment, user terminals (200) contact the stamp card management server (100) to check information on each used and unused stamp card. The users tend to check the quantity of their stamp cards and use them less given the scarcity value of the card. This will present the country of issue with greater profits as much as the denomination marked on the card.

Moreover, user terminals (200) contact the stamp card management server (100), provide payment request signals to pay for postage and receive the resultant payment completion signals from the stamp card management server (100).

At the time, user terminals (200) can send payment request signals to the stamp card management server (100) using a mobile or actual stamp card and receive payment completion signals from the server (100).

User terminals (200) receive payment completion signals from the stamp card management server (100) and output the relevant signals to the output equipment (300) for printing.

In an exemplary embodiment, user terminals (200) send stamp printing signals to the output equipment (300) when the user wants to receive a stamp by printing.

In the above exemplary embodiment, user terminals (200) contact the stamp card management server (100); pay postage with a stamp card; and generate PDS (Personal Digital Stamp) by printing out commemorative postmarks and stamps certified in the countries of issue using a personal output device (300) with no constraint on user location; provided that these commemorative postmarks shall be used only one day unlike the existing commemorative postmarks.

In a different exemplary embodiment, user terminals (200) send signals on delivery destination to the output device (300) when the user wants to receive a stamp by delivery.

Output equipment (300) prints out stamps according to the input printing signals. The equipment (300) can take on the form of a printer or a press.

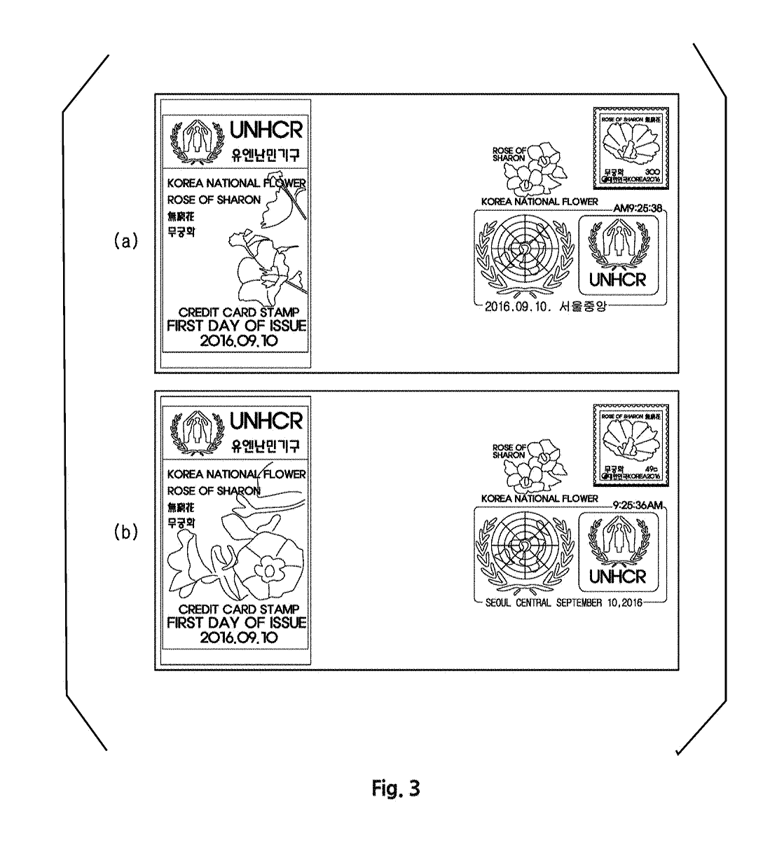

Output equipment (300) can print out stamps as shown in FIG. 2 (a) or 2 (c) after receiving output signals from user terminals (200).

For instance, output equipment (300) can print stamps for domestic mail as shown in FIG. 2 (a) or stamps for overseas mail in FIGS. 2 (b) and 2 (c). Like this, users can print out a stamp through the output device (300), affix it to an item of mail and post the item.

For one, output equipment (300) also prints an FDC for domestic mail as depicted in FIG. 3 (a) and an FDC for overseas mail as in FIG. 3 (b).

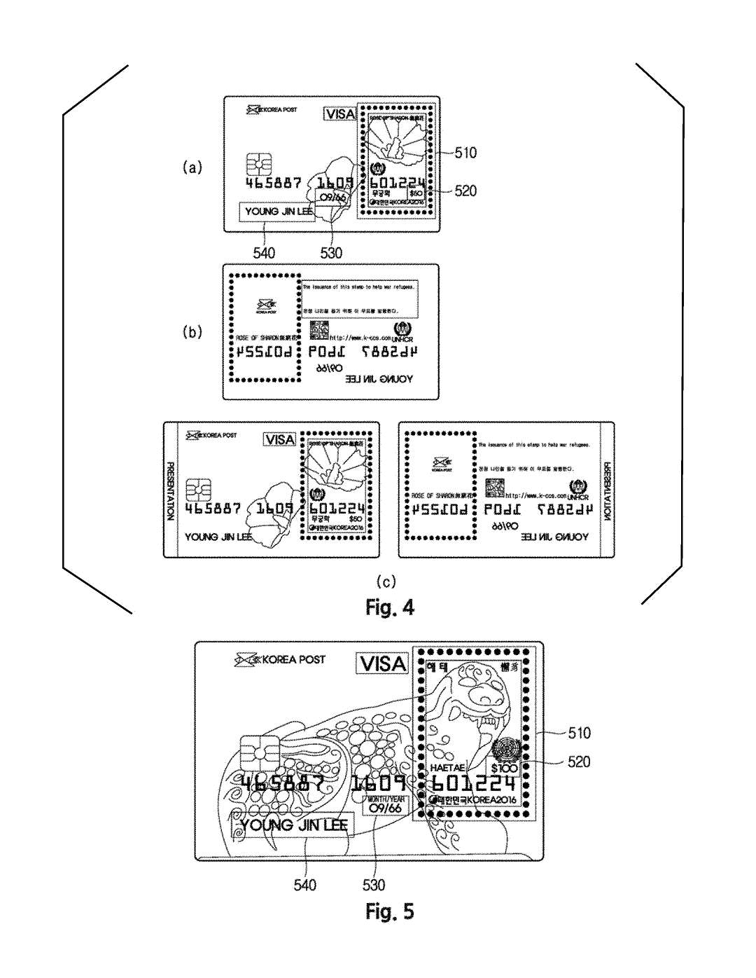

FIGS. 4 and 5 are diagrams illustrating a stamp card according to an exemplary embodiment of the present invention.

As FIGS. 4 and 5 show, each stamp card has its own purpose of issuance. For example, a stamp card in FIG. 4 (C) is for presentation and the one in FIG. 5 is for fund raising. Such issuing purposes may be described on the back of the card as in Reference No. (550) in FIG. 4 (b).

The front of each stamp card contains symbol puncturing (510), available value denominated in national currency (520), effective period (530) and the buyer's name (540) as shown in FIGS. 4 (a) and 5.

The available value denominated in national currency (520) on the front of the card represents a postage rate payable with a stamp card and the bidding price for the stamp card auction shall be more than the relevant amount.

The effective period (530) is a time period during which users can pay postage by stamp card and it is set longer than a specific duration from the issue date (e.g., 50 or 100 years) to raise sovereign credit rating and promote card sales.

The buyer's name (540) is a name of the auction winner among the stamp card auction bidders. Stamp cards with an imprinted name of the winner can boost competition among the users to buy the first card and stimulate their purchase desires.

As mentioned above, stamp cards in the present invention are not for one-time use like conventional stamps but for repeated use until the amount of money marked on their front (520) is depleted.

The back of the stamp card contains the purpose of stamp issuance (550) and contact information with the stamp card management server. The contact info takes on the form of QR code, bar code, etc. Therefore, users can log into the stamp card management server (100) using that contact info and attain all information in the stamp card.

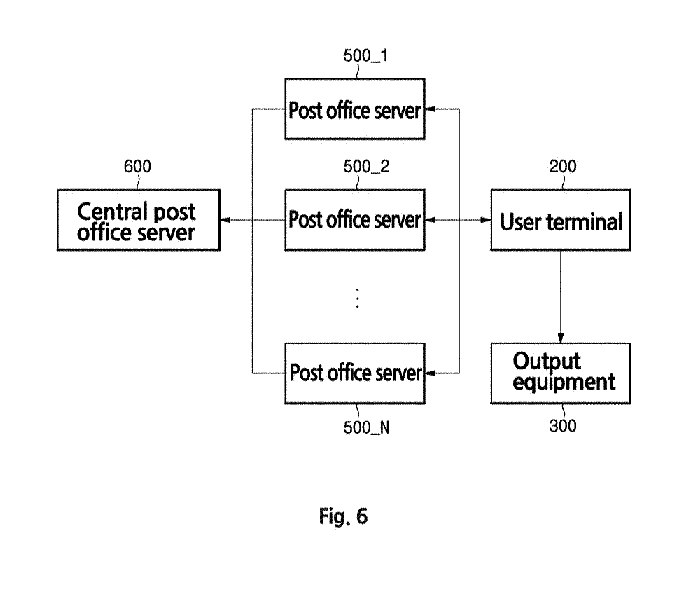

FIG. 6 is a network composition diagram illustrating a postage stamp issuing system using a stamp card according to another exemplary embodiment of the present invention. In this embodiment, the system applies to an online post office and card holders contact the office server through their terminal, issue stamps or buy FDCs, and print them via personal output devices or have them delivered.

As FIG. 6 shows, a postage stamp issuing system using a stamp card comprises user terminals (200), output equipment (300), post office servers (500_1˜500_N) and central post office server (600).

User terminals (200) contact post office servers (500_1˜500_N) and send request signals for making an FDC to the server. Those signals relate to the use or disuse of the envelop, cachet, and plastic cover. The envelop represents an FDC, the cachet represents a figure inserted in the FDC. The use or disuse of the cachet is decided by the user option. The plastic cover represents a package to make an FDC delivered clean.

Then, user terminals (200) transmit using the stamp card the signals calling for postage information by item (e.g., regular or registered mail) to post office servers (500_1˜500_N) and receive payment completion signals from those servers (500_1˜500_N).

Post office servers (500_1˜500_N) receive signals requesting an FDC from user terminals (200) and handle the making and delivery of the FDC according to the user option.

To manufacture an FDC, post office servers (500_1˜500_N) provide a postage payment procedure to user terminals (200) and process the payment according to information on the stamp card and item type (e.g., regular or registered mail).

In an exemplary embodiment, when the remainder out of the initial value marked on the front of the stamp card is greater than the postage rate, post office servers (500_1˜500_N) proceed with the purchase process and update the remaining amount.

In yet another exemplary embodiment, post office servers (500_1˜500_N) send signals to user terminals (200) that prohibit card purchase when the remainder out of the initial value marked on the front of the stamp card is smaller than the postage rate.

Post office servers (500_1˜500_N) provide a procedure to print an FDC according to the desired reception method transmitted by the user terminal (200) through the output device (300) connected with the terminal (200); or proceed with delivery of an FDC according to delivery destination information sent by the terminal (200).

In the above exemplary embodiment, post office servers (500_1˜500_N) send signals requesting the making and delivery of an FDC to the central post office server (600) in case that the user sends a signal through a terminal (200) that he or she wants to receive a stamp by delivery.

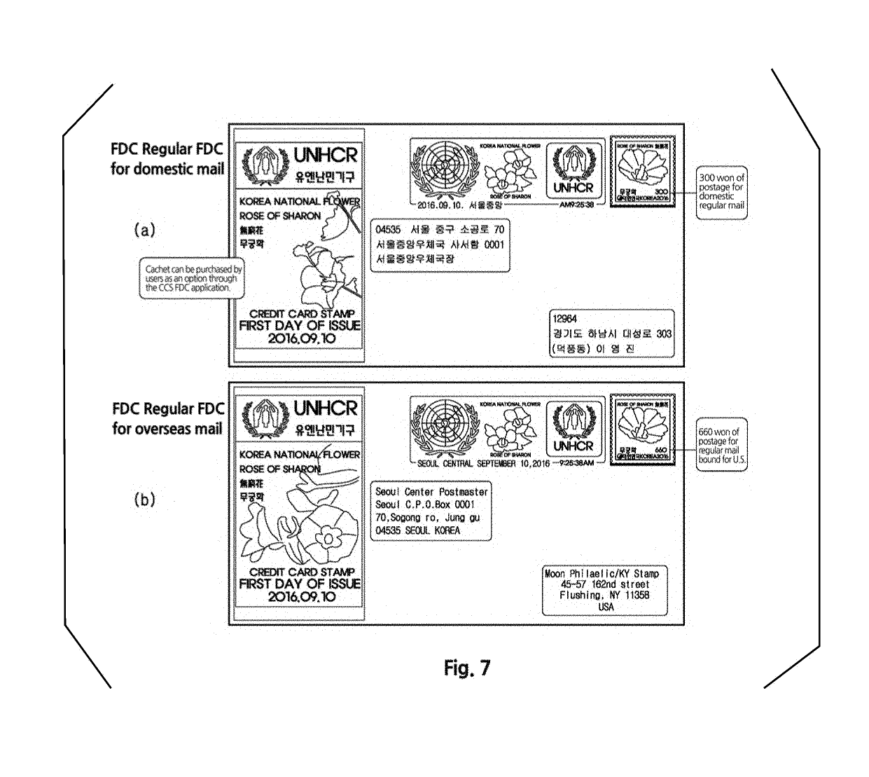

The central post office server (600) processes the manufacturing and delivery of the FDC. For instance, the server (600) makes a regular FDC for domestic mail as depicted in FIG. 7 (a) and a regular FDC for overseas mail as in FIG. 7 (b).

Output devices (300) print an FDC according to output signals from user terminals (200).

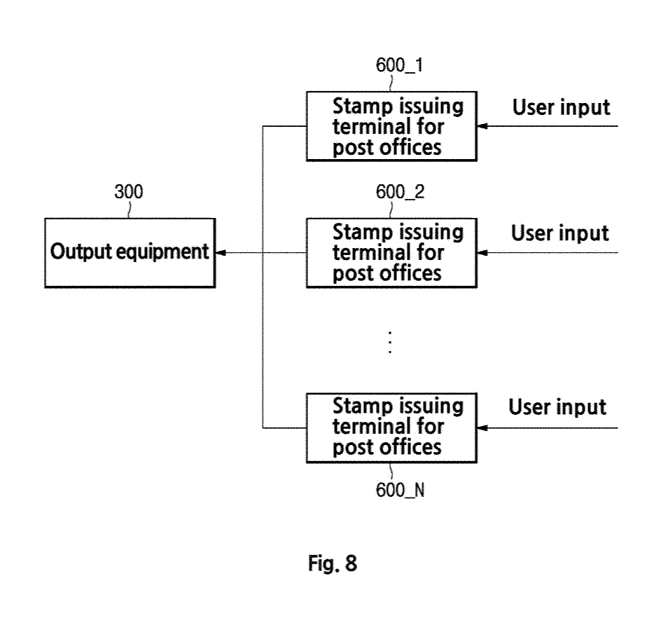

FIG. 8 is a network composition diagram illustrating a postage stamp issuing system using a stamp card according to another exemplary embodiment of the present invention. In the embodiment in FIG. 8, the system applies to the premise of an offline post office and only card holders can issue stamps or buy FDCs and print them in the office.

As FIG. 8 shows, a postage stamp issuing system using a stamp card comprises stamp issuing terminals for post offices (600_1˜600_N) and output equipment (300).

Stamp issuing terminals for post offices (600_1˜600_N) receive signals to make an FDC and generate and print it through the output device (300) according to user options.

Stamp issuing terminals for post offices (600_1˜600_N) print stamps through the output device (300) according to signals to make stamps.

For this, stamp issuing terminals for post offices (600_1˜600_N) provide a postage payment procedure and process the payment depending on information on the stamp card and item type (e.g., regular mail, registered mail, etc.) received through the procedure.

In an exemplary embodiment, when the remainder out of the initial value marked on the front of the stamp card is greater than the postage rate, stamp issuing terminals for post offices (600_1˜600_N) proceed with the purchase process and update the remaining amount.

In yet another exemplary embodiment, stamp issuing terminals for post offices (600_1˜600_N) send signals that prohibit card purchase to user terminals (200) when the remainder out of the initial value marked on the front of the stamp card is smaller than the postage rate.

When the rates for issuing stamps or making FDCs are payed, stamp issuing terminals for post offices (600_1˜600_N) send output signals to the output device (300) for printing them.

The output device (300) issues stamps or prints FDCs according to output signals from stamp issuing terminals for post offices (600_1˜600_N).

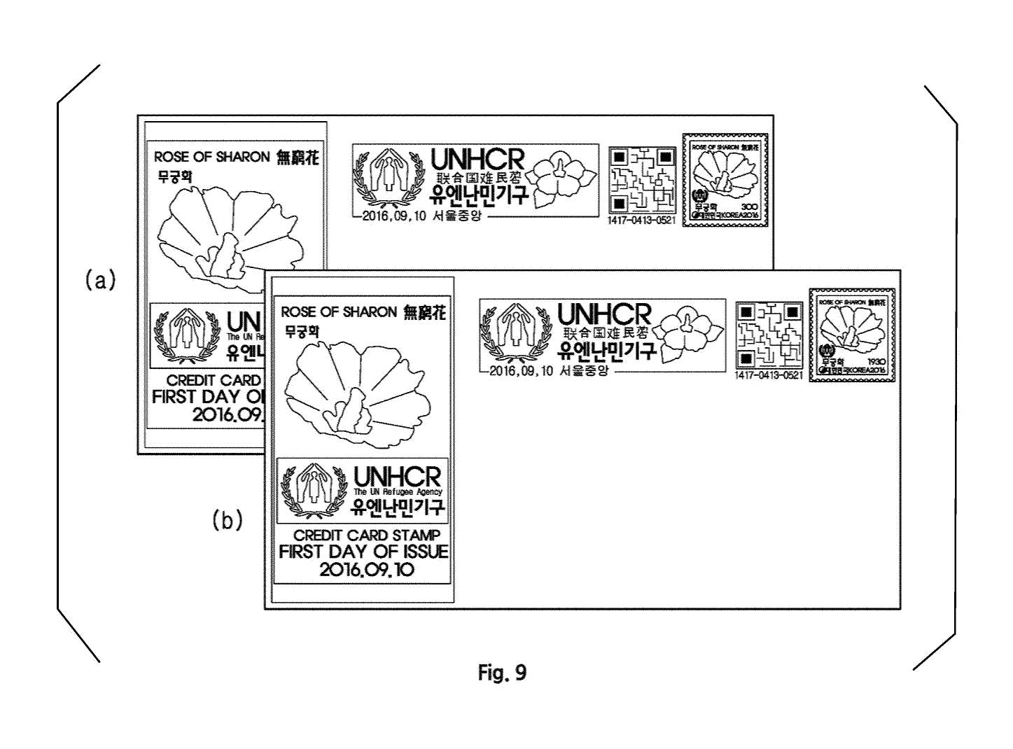

For example, output equipment (300) prints an FDC for regular mail as in FIG. 9 (a) and an FDC for registered mail in FIG. 9 (b).

In another embodiment, output equipment (300) creates personal digital stamps by printing a stamp for regular mail as in FIG. 10 (a) and a commemorative postmark and stamp for registered mail in FIGS. 10 (b) and 9 (b). In case of registered mail, the output equipment (300) prints out the certification code (e.g., QR code) and the code can come in different colors according to item types such as regular post registration or air post registration and includes data other than registration numbers.

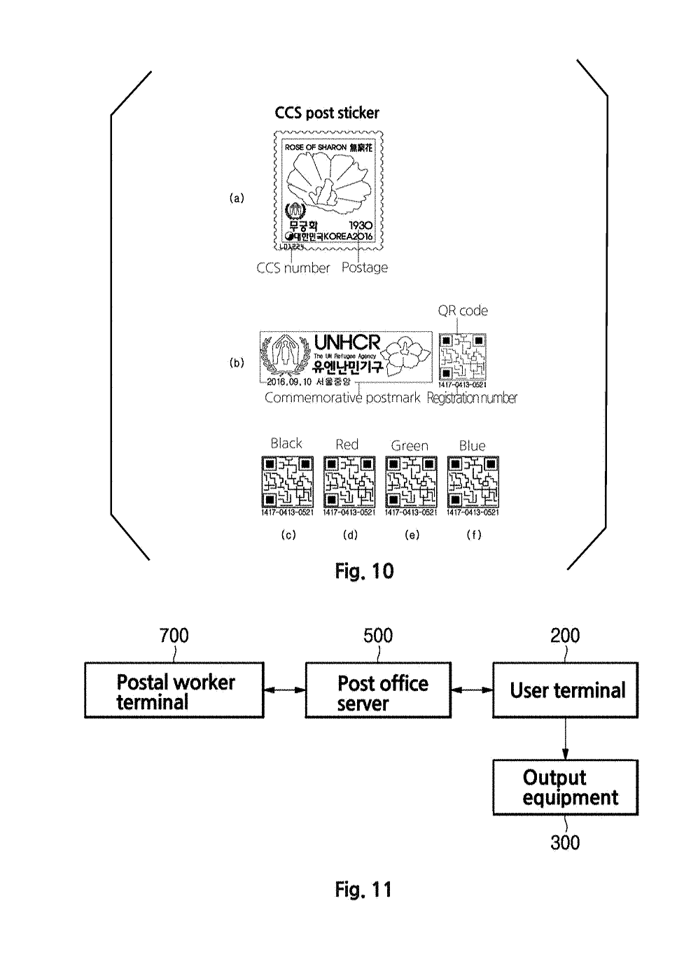

FIG. 11 is a network composition diagram illustrating a postage stamp issuing system using a stamp card according to another exemplary embodiment of the present invention.

As FIG. 11 shows, a postage stamp issuing system using a stamp card comprises user terminals (200), output devices (300), post office servers (500) and postal worker terminals (700).

A postage stamp issuing system using a stamp card comprises user terminals (200), output devices (300), post office servers (500) and postal worker terminals (700).

User terminals (200) contact the post office server (500), register postal information (e.g., a receiver, sender, item type, etc.) with it, transmit payment request signals to the applicable post office server (500) and receive payment completion signals from it (500) depending on the payment results.

At the time, user terminals (200) can transmit payment request signals to the stamp card management server (100) and receive the payment completion signals from it using mobile or actual cards.

User terminals (200) receive payment completion signals from the post office server (500) and print a postal registration certificate through output equipment (300) according to the output procedure from the server (500).

User terminals (200) send to the post office server (500) the signals that indicate affixation of a postal registration certificate to the mailed item.

The output device (300) prints out a postal registration certificate according to the output signals from user terminals (200).

If the above output device (300) is a dedicated printer with a sensor that measures the weight of a mailed item, a user can weigh the item, pay for postage, print a postal registration certificate and affix it to the item using the output device (300) at home.

The post office server (500) receives payment request signals from user terminals (200), handles the payment of a postage rate, and sends the payment completion signals to the user terminals (200).

Then, the post office server (500) provides a procedure to print a postal registration certificate to the user terminal (200) after postage payment.

The post office server (500) receives from the user terminal (200) the signals notifying that a postal registration certificate has been affixed to a mailed item and sends mail pickup signals including user information to the postal worker terminal (700).

The post office server (500) offers the mail delivery status to user terminals (200) according to signals on the completion of mail collection transmitted by the postal worker terminal (700).

The postal worker terminal (700) receives mail pickup signals from the post office server (500) and displays user information contained in the signals. In response, a postal worker goes to the user's location, collects an item, and brings it to the post office. The office prints out a sticker suitable for its postage, affixes it to the item and deals with its delivery.

The postal worker terminal (700) also transmits signals on the completion of mail collection to the post office server (500) after mail collection.

As a result, post office tellers don't need to record every piece of postal information and users are free from inconvenient trip to a post office.

Though the present invention has been so far described with restricted exemplary embodiments and drawings, it is not limited to the aforementioned embodiments and those having ordinary skills in the same field can make a variety of amendments and modifications based on such description. Thus, this invention idea shall be understood just within the scope of the patent claims which follow, and all modifications equal or equivalent to the present invention idea shall be deemed to belong to its scope.

1. In a postage stamp issuing method using a stamp card executed on the stamp card management server,
the method comprising the following steps:
offering a sales procedure by stamp card type and issuing stamp cards through the said procedure;
receiving purchase request signals from a user terminal, offering a procedure to select mail options, and deciding a payment method according to the information and service type chosen by the user through the said procedure;
offering a payment procedure depending on whether pre-payment or post-payment or a procedure to print a postal registration certificate; and
offering a procedure to issue a stamp or print out an FDC after the postage is payed through the said procedure.

2. In a postage stamp issuing method using a stamp card of claim 1,
the step that the stamp card management server offers a sales procedure by stamp card type and issues stamp cards through the procedure comprising:
offering a sales procedure for a regular stamp card if the card is a regular type; and
offering an auction procedure for a commemorative stamp card if the card is a commemorative type.

3. In a postage stamp issuing method using a stamp card of claim 2,
the step that offers an auction procedure for a commemorative stamp card if the card is a commemorative type comprising:
producing stamp cards based on the purpose of issuance, effective period, available value denominated in national currency, stamp number and data to access the stamp card management server;
providing the card auction procedure for user terminals; and
designating a particular user as an auction winner among the bidders, issuing a stamp card and dealing with its delivery to the winner.

4. In a postage stamp issuing method using a stamp card of claim 1,
the step that decides a payment method according to the information and service type chosen by the user through the said option selection procedure comprising:
deciding to prepay postage when the type of the mailed item chosen by the option selection procedure is a regular type;
offering a payment procedure using information chosen through the mail option selection procedure; and
offering a procedure to issue a stamp or print out an FDC after the postage is payed through the payment procedure.

5. In a postage stamp issuing method using a stamp card of claim 1,
the step that decides a payment method according to the information and service type chosen by the user through the said option selection procedure comprising:
in case that though an item of mail is registered mail, the user has a printer that can weigh it, deciding the prepaid method and receiving its weight data from the printing device;
deciding the postage using information chosen through the mail weight and option selection procedure transmitted by the printing device and offering a postage payment procedure; and
comparing the postage rate of the mailed item and that in the same line, accordingly levying penalties on the user and deciding whether to allow him or her to keep running the personal post office based on those penalties.

6. In a postage stamp issuing method using a stamp card of claim 1,
the step that decides a payment method according to the information and service type chosen by the user through the said option selection procedure comprising:
providing a postal registration certificate to the home pickup service user although registered mail is chosen through the mail option selection procedure; and
implementing post-payment after the item of mail is weighed at a post office and its postage rate is determined using information chosen through the mail weight and option selection procedure.

7. A postage stamp issuing system using a stamp card comprising:
the stamp card management server
that offers a sales procedure by stamp card type and issues stamp cards through the procedure; receives purchase request signals from a user terminal and offers a procedure to select mail options; decides a payment method according to the information and service type chosen by the user through the procedure; offers a payment procedure depending on whether pre-payment or post-payment or a procedure to print a postal registration certificate; and offers a procedure to issue a stamp or print out an FDC after the postage is payed through the procedure;
user terminals
that log into the said stamp card server; buy stamp cards according to the said card sales procedure, select an option through the said procedure to select mail options; pay postage calculated based on the option information; and generate signals for issuing a stamp or printing an FDC; and
the output equipment
that prints out stamps according to signals from the user terminal.

8. In the stamp card management server of claim 7,
the postage stamp issuing system using a stamp card
offers a sales procedure for regular stamp cards and an auction procedure for commemorative cards.

9. In the stamp card management server of claim 8,
the postage stamp issuing system using a stamp card
produces stamp cards based on the purpose of issuance, effective period, available value denominated in national currency, stamp number and data to access the stamp card management server; provides the card auction procedure for user terminals; and designates a particular user as an auction winner among the bidders and issues a stamp card and deals with its delivery to the winner.

10. In the stamp card management server of claim 7,
in case the type of the mailed item chosen by the mail option selection procedure is a regular type,
the postage stamp issuing system using a stamp card decides to prepay postage; offers a payment procedure using information chosen through the mail option selection procedure; and
offers a procedure to issue a stamp or print out an FDC after the postage is payed through the payment procedure.

11. In the stamp card management server of claim 10,
in case that though an item of mail is registered mail, the user has a printer
that can weigh it,
the postage stamp issuing system using a stamp card
decides the prepaid method and receives its weight data from the printing device; decides the postage using information chosen through the mail weight and option selection procedure transmitted by the printing device and offers a postage payment procedure; and compares the postage rate of the mailed item and that in the same line, accordingly levies penalties on the user and decides whether to allow him or her to keep running the personal post office based on those penalties.

12. In the stamp card management server of claim 10,
the postage stamp issuing system using a stamp card
provides a procedure to print a postal registration certificate to the home pickup service user although registered mail is chosen through the mail option selection procedure; implements post-payment after the item of mail is weighed at a post office and its postage rate is determined using information chosen through the mail weight and option selection procedure; and compares the postage rate of the mailed item and that in the same line, accordingly levies penalties on the user and decides whether to allow him or her to keep running the personal post office based on those penalties.
